(19) United States
(12) Patent Application Publication
(10) Pub. No.: US 2026/0153985 A1
(43) Pub. Date: Jun. 4, 2026

(54) INTERACTION METHOD AND SYSTEM FOR CURVED SCREEN TOUCH WITH PLANAR MAPPING

(71) Applicant: Dipal AI Technology Co., Ltd., Shanghai (CN)

(72) Inventor: Weijia Li, Shanghai (CN)

(21) Appl. No.: 19/464,780

(22) Filed: Jan. 30, 2026

(30) Foreign Application Priority Data
Dec. 8, 2025 (CN) 202511834762.6

(51) Int. Cl. G06F 3/0488; G06F 3/01; G06F 3/041

(52) U.S. Cl. CPC G06F 3/0488; G06F 3/012; G06F 3/013; G06F 3/0414

(57) ABSTRACT

The present disclosure provides an interaction method and system for curved screen touch with planar mapping. The method and system achieve accurate conversion of touch to planar UV coordinates and improve the mapping accuracy and scene adaptability. The method includes: acquiring features of a curved screen and user posture data; responding to a touch operation of a user on the curved screen and determining dynamic touch parameters based on the touch operation; determining a base mapping transformation matrix based on the features of the curved screen and the user posture data; adjusting the base mapping transformation matrix based on the dynamic touch parameters to obtain an optimized mapping transformation matrix; and converting the touch operation to planar UV coordinates based on the optimized mapping transformation matrix to output the planar UV coordinates.

### TECHNICAL FIELD

The present disclosure relates to the technical field of data processing, and in particular to an interaction method and system for curved screen touch with planar mapping.

### BACKGROUND

With the development of display technology, curved screens are widely used in vehicle-mounted systems, smart homes, large-scale interactive devices, and the like due to an immersive visual experience. However, due to the curved surface feature of the curved screen, there exists a natural difference between touch coordinates and coordinates of a planar user interface (UI). When a user touches the edges or different areas of the curved screen, the coordinates directly mapped to a planar interaction interface are prone to geometric distortion, resulting in reduced interaction accuracy.

In the prior art, in most curved touch mapping methods, simple linear transformation or fixed-parameter calibration is employed without considering the influence of the curvature differences of the curved screens, changes in the operation perspectives of the users, and dynamic touch features, making it difficult to meet the demand for high-precision interaction. In addition, conventional methods have insufficient compensation capabilities for multi-touch collaborative mapping, device jitter, or screen deformation, which further limits the adaptability between curved screens and planar interaction interfaces.

### SUMMARY

The present disclosure provides an interaction method and system for curved screen touch with planar mapping, which achieves an accurate conversion of touch to planar UV coordinates and improves the mapping accuracy and scene adaptability.

To achieve the above objective, the present disclosure adopts the following technical solution:

In a first aspect, the present disclosure provides an interaction method for curved screen touch with planar mapping, including:
acquiring features of a curved screen and user posture data; responding to a touch operation of a user on the curved screen, and determining dynamic touch parameters based on the touch operation; determining a base mapping transformation matrix based on the features of the curved screen and the user posture data; adjusting the base mapping transformation matrix based on the dynamic touch parameters to obtain an optimized mapping transformation matrix; and converting the touch operation to planar UV coordinates based on the optimized mapping transformation matrix to output the planar UV coordinates.

According to the above technical means, a base matrix is generated by combining features of the curved screen and a user posture, and through the optimization of the dynamic touch parameters, the accurate conversion from touch to coordinates of the planar UV is realized. This improves the mapping accuracy and scenario adaptability, reduces the offset jitter, enhances the interaction fluency and stability, and optimizes the user experience.

In another implementation mode, the acquiring touch point physical parameters and determining dynamic touch parameters based on the touch operation may be specifically implemented as follows: acquiring three-dimensional spatial coordinates, a touch pressure value, a contact area, and a touch movement speed of the touch operation on the curved screen; and determining the three-dimensional spatial coordinates, the touch pressure value, the contact area, and the touch movement speed as the dynamic touch parameters. By acquiring the three-dimensional spatial coordinates, the touch pressure value, the contact area, and the touch movement speed as the dynamic touch parameters, the spatial position and physical features of the touch operation can be accurately captured to provide a multi-dimensional ground for mapping matrix optimization, which effectively improves the accuracy and adaptability from curve surface to planar mapping and improve the interaction accuracy and fluency.

In another implementation mode, the determining a base mapping transformation matrix based on the features of the curved screen and the user posture data may be specifically implemented as follows: constructing a three-dimensional curved surface model based on the features of the curved screen; determining a spatial projection relationship from a perspective of the user in combination with the user posture data; and generating the base mapping transformation matrix, where the features of the curved screen include a curvature type, a physical dimension, a radius of curvature, a spatial position, and an initial posture; the user posture data includes a face orientation angle, gaze focus point coordinates, and a relative distance between the user and the curved screen; and the curvature type includes a cylindrical surface or a partial spherical surface. By fusing the multi-dimensional features of the curved screen and the user posture data to construct the three-dimensional model and determine the spatial projection relationship, the generated base mapping matrix can be accurately adapted to different curvature screens and user perspectives to improve the mapping reference precision, thereby laying a reliable foundation for subsequent optimization and enhancing the scenario adaptability.

In another implementation mode, the constructing a three-dimensional curved surface model based on the features of the curved screen may be specifically implemented as follows: when the curvature type of the curved screen is the cylindrical surface, constructing a first three-dimensional model with a center of a curved surface as an origin and an axial direction in a horizontal direction according to the physical dimension and the radius of curvature of the curved screen; and when the curvature type of the curved screen is the partial spherical surface, constructing a second three-dimensional model corresponding to the partial spherical surface according to the physical dimension and the radius of curvature of the curved screen. Two curvature types for the cylindrical surface and the partial spherical surface are achieved. By respectively constructing precise three-dimensional models according to the parameters of the curved screen, the geometric features of different curved screens can be accurately restored, thereby providing a practical-oriented base model for subsequent mapping matrix generation and improving the mapping reference accuracy and scenario adaptability.

In another implementation mode, the generating a base mapping transformation matrix may be specifically implemented as follows: determining a spatial direction vector of a line of sight of the user based on the face orientation angle in the user posture data; determining a virtual observation point position of the perspective of the user based on the spatial direction vector of the line of sight of the user, the relative distance between the user and the curved screen, and the gaze focus point coordinates; with the virtual observation point as an origin, constructing a perspective projection relationship from a three-dimensional curved surface model of the curved screen to a planar interaction interface, and determining projection transformation parameters from any point on the curved surface model to the planar interaction interface; and integrating the projection transformation parameters into a matrix of a preset dimension to generate the base mapping transformation matrix. Determining the line of sight vector and the virtual observation point in combination with the user posture data and constructing a perspective projection relationship to generate the base matrix can precisely match the user perspective and eliminate the mapping deviation caused by the difference of observation positions, thereby improving the visual consistency and accuracy of conversion from curve to plane.

In another implementation mode, the adjusting the base mapping transformation matrix based on the dynamic touch parameters to obtain an optimized mapping transformation matrix may be specifically implemented as follows: mapping the touch pressure value to an adjustment coefficient of a nonlinear compensation function; determining a curved surface curvature deviation compensation value based on the contact area; generating a motion trajectory prediction weighting factor based on the touch movement speed; determining the adjustment coefficient, the curved surface curvature deviation compensation value, and the motion trajectory prediction weighting factor as compensation parameters; and adjusting the base mapping transformation matrix based on the compensation parameters to form the optimized mapping transformation matrix. Extracting the compensation parameters through the pressure, the contact area, and the speed, and dynamically adjusting the base matrix to obtain the optimized matrix can offset the nonlinear deviations and trajectory jitter in the touch process in a targeted manner, thereby improving the mapping precision in a complex operation and enhancing the interaction fluency and accuracy.

In another implementation mode, the converting the touch operation to planar UV coordinates based on the optimized mapping transformation matrix to output the planar UV coordinates may be specifically implemented as follows: acquiring three-dimensional spatial coordinates of the touch operation; inputting the three-dimensional spatial coordinates into the optimized mapping transformation matrix to obtain original coordinates in a planar coordinate system; and normalizing the original coordinates to obtain the planar UV coordinates with a value range of [0, 1]. By converting the three-dimensional coordinates to the planar original coordinates through the optimized matrix and performing normalization to obtain the planar UV coordinates with the value range of [0, 1], the conversion precision is guaranteed, and the coordinates are adapted to various planar interaction interfaces, thereby enhancing the universality and ensuring that the interaction system precisely responds to the touch operation.

In another implementation mode, the features of the curved screen further include a screen material light transmittance parameter.

In another implementation mode, the method provided by the present disclosure further includes correcting the acquisition accuracy of the user posture data based on the screen material light transmittance parameter. Correcting the collecting precision of the user posture data in combination with the screen material transmissivity parameter can offset the image noise or feature extraction errors caused by a transmissivity difference and enhance the accuracy of the posture data, thereby providing a reliable ground for subsequent mapping matrix generation and enhancing the stability of the system with different screen materials.

In another implementation mode, the method provided by the present disclosure further includes: receiving an interaction response result returned based on the planar UV coordinates, wherein the interaction response result comprises an actual matching deviation value between the planar UV coordinates and planar UI elements; determining a mapping compensation coefficient based on the actual matching deviation value; and optimizing a generation process of the base mapping transformation matrix based on the mapping compensation coefficient. Acquiring the matching deviation through the interaction response result and determining the compensation coefficient to optimize base matrix generation to form a closed-loop calibration mechanism can dynamically correct the systematic mapping deviation to continuously improve the mapping precision, thereby enhancing the interaction response accuracy and the self-optimizing capability of the system.

In a second aspect, the present disclosure provides an interaction system for curved screen touch with planar mapping, including:
an acquisition module, configured to acquire features of a curved screen and user posture data;
a feature extraction module, configured to respond to a touch operation of a user on the curved screen, and determine dynamic touch parameters based on the touch operation;
a matrix determination module, configured to determine a base mapping transformation matrix based on the features of the curved screen and the user posture data;
a matrix optimization module, configured to adjust the base mapping transformation matrix based on the dynamic touch parameters to obtain an optimized mapping transformation matrix; and
an operation mapping module, configured to convert the touch operation to planar UV coordinates based on the optimized mapping transformation matrix, to output the planar UV coordinates.

The solution provided in the second aspect is used to implement the method provided in the first aspect, a specific implementation of which is not repeatedly described herein. For the technical effects corresponding to any implementation mode in the solution provided in the above second aspect, reference may be made to the technical effects corresponding to any implementation mode in the above first aspect, which will not be repeated here.

It should be noted that, on the premise that the solutions are not contradictory, various possible implementation modes of any one of the above aspects can be combined.

### BRIEF DESCRIPTION OF THE DRAWINGS

To describe the technical solutions in the embodiments of the present disclosure more clearly, the accompanying drawings required for describing the embodiments will be briefly introduced below. Apparently, the accompanying drawings in the following description are only some embodiments of the present disclosure, and those of ordinary skill in the art can also obtain other accompanying drawings based on these accompanying drawings without exerting creative efforts.

FIG. 1 is a schematic diagram of an architecture of a computer system provided by an embodiment of the present disclosure.

FIG. 2 is a flowchart of one interaction method for curved screen touch with planar mapping provided by an embodiment of the present disclosure.

FIG. 3 is a flowchart of another interaction method for curved screen touch with planar mapping provided by an embodiment of the present disclosure.

FIG. 4 is a schematic structural diagram of an interaction system for curved screen touch with planar mapping provided by an embodiment of the present disclosure.

FIG. 5 is a product schematic diagram of an interaction system for curved screen touch with planar mapping provided by an embodiment of the present disclosure.

### DETAILED DESCRIPTIONS OF THE EMBODIMENTS

In the embodiments of the present disclosure, to facilitate a clear description of the technical solutions of the embodiments of the present disclosure, terms such as “first” and “second” are used to distinguish identical or similar items that have substantially the same function and effect. Those skilled in the art will understand that terms such as “first” and “second” do not limit the quantity or execution order, and such terms also do not limit that the items must be different. There is no sequence or order of magnitude between the technical features described by “first” and “second”.

In the embodiments of the present disclosure, words such as “by way of example” or “for example” are used to represent examples, illustrations, or explanations. In the embodiments of the present disclosure, any embodiment or design solution described as “by way of example” or “for example” should not be construed as more preferred or more advantageous than other embodiments or design solutions. Specifically, the use of words such as “by way of example” or “for example” is intended to present relevant concepts in a specific manner to facilitate understanding.

In the embodiments of the present disclosure, “at least one” can also be described as “one or more”. “A plurality of” can refer to two, three, four, or more, which is not limited herein.

In addition, the network architectures and scenarios described in the embodiments of the present disclosure are intended to describe the technical solutions of the embodiments of the present disclosure more clearly, and do not constitute limitations on the technical solutions provided in the embodiments of the present disclosure. Those of ordinary skill in the art will understand that with the evolution of network architectures and the emergence of new business scenarios, the technical solutions provided in the embodiments of the present disclosure are also applicable to similar technical problems.

By way of example, the touch mapping solutions for curved screens in the prior art have problems such as insufficient precision and limited adaptability, which are briefly described as follows.

In the prior art, a linear conversion method with fixed parameters is mostly used for touch and planar mapping of the curved screen: constructing coordinate mapping tables in one-to-one correspondence between the curved screen and the planar interaction interface or performing simple geometric correction based on the screen curvature. Some solutions introduce a static posture of the user as a mapping reference, but fail to consider the influence of the real-time posture changes and dynamic touch features of the user.

However, the above technology is limited in adaptability and precision, leading to problems such as geometric distortion and response deviation when the curved screen touch operations are mapped to the planar interaction interface. For example, when the head of the user is tilted toward one side of the screen, the fixed mapping in the prior art causes a deviation between the projected position of the touch point on the planar interaction interface and the position perceived by the vision of user. For the partial spherical screen with a large curvature variation, linear transformation cannot compensate for the curvature differences in different regions of the curved surface, leading to obvious stretching or compression of the touch operations at the screen edges after mapping. Failing to integrate dynamic parameters such as the touch pressure and the movement speed, when the user slides fast or applies different pressures, the mapped trajectory is prone to jitter or deviation, which affects the fluency of interaction.

These problems make it difficult for the prior art to meet the high-precision and immersive interaction requirements of the curved screen; especially in scenarios such as in-vehicle and gaming scenarios, where high requirements for real-time performance and accuracy are demanded, the user experience is limited.

On this basis, the present disclosure provides an interaction method for curved screen touch with planar mapping. A base matrix is generated by combining features of the curved screen and a user posture, and through the optimization of the dynamic touch parameters, accurate conversion from touch to coordinates of the planar UV is realized. This improves the mapping accuracy and scenario adaptability, reduces the offset jitter, enhances the interaction fluency and stability, and optimizes the user experience.

The solutions provided by the embodiments of this disclosure will be described below in conjunction with the accompanying drawings.

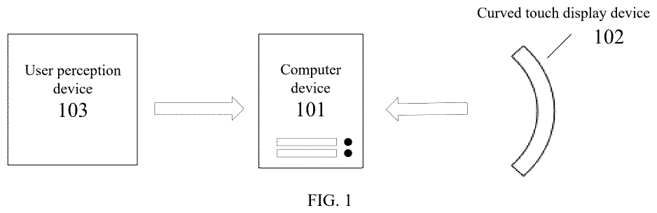

The solutions provided by the present disclosure may be applied to a computer system shown in FIG. 1, and FIG. 1 is a schematic diagram of an architecture of the computer system.

By way of example, the computer system shown in FIG. 1 includes a computer device 101, a curved touch display device 102, and a user perception device 103.

The computer device 101 may be an intelligent terminal or a dedicated control unit with data processing and algorithm operation capabilities, such as an industrial-grade interactive host, an embedded computing module, or a personal computer.

Optionally, the computer device 101 includes a processor, a memory, and input/output interfaces, configured to store curved screen feature parameters, user posture data, and a mapping algorithm program.

Optionally, the computer device 101 may establish data connections with the curved touch display device 102 and the user perception device 103 through a bus or a wireless communication module to achieve real-time data transmission.

Optionally, an operating system and a dedicated interaction engine operate in the computer device 101 to support multi-threaded processing of touch data and posture analysis, so as to ensure the real-time performance of mapping transformation.

Specifically, the core function of the computer device 101 is to execute the interaction method for curved screen touch with planar mapping, including generating the base mapping transformation matrix, the optimized matrix parameters, and outputting the planar UV coordinates.

Specifically, the computer device 101 may efficiently complete conversion from the three-dimensional coordinates to the planar UV coordinates by invoking a built-in matrix operation library and a graphics processing interface.

Optionally, the computer device 101 is further equipped with a debugging interface, which supports developers to upload curved screen feature calibration data or update the mapping algorithm version.

Optionally, the computer device 101 may automatically load a preset curvature parameter configuration file according to the model of the curved touch display device 102, thereby simplifying a system deployment process.

Optionally, the computer device 101 includes an exception handling module, which may automatically start backup mapping parameters when a data transmission interruption or calculation error is detected, thereby guaranteeing the interaction continuity.

The curved touch display device 102 may be an interaction terminal integrated with a curved display panel and a touch sensing layer. The screen curvature of the curved touch display device may be preset as a curvature of the cylindrical surface or the local spherical surface, such that the curved touch display device has double functions of displaying images and detecting the touch operations.

Optionally, the touch sensing layer of the curved touch display device 102 supports multi-point touch using a capacitive sensing technology, with a touch sampling rate being not less than 120 Hz, so as to capture fast sliding or fine tapping operations.

Optionally, a pressure sensor array is integrated on a surface of the curved touch display device 102, which may collect a pressure value and contact area of a touch point and transmit the same as the dynamic touch parameters to the computer device 101.

Specifically, the physical parameters of the curved touch display device 102 will be pre-sored in device firmware, and the computer device 101 may read these parameters through a communication protocol to construct the three-dimensional curved surface model.

The user perception device 103 refers to a hardware device configured to collect the user posture data, which may be a combination of a depth camera, an infrared sensor, and an eye tracking module, and is specifically configured to capture a face orientation of the user, a gaze landing point, and a relative distance to the screen in real time.

Optionally, the depth camera of the user perception device 103 uses structured light or a time-of-flight technology to ensure that the relative distance data between the user and the screen is accurate.

Optionally, the user perception device 103 is integrated with a low-power consumption processing chip, which may locally complete face key point extraction and initial posture calculation, thereby reducing the data volume transmitted to the computer device 101.

Specifically, a sampling frequency of the user perception device 103 is synchronized with a touch sampling rate of the curved touch display device 102 to ensure the temporal matching between the posture data and the touch data.

Specifically, the computer device 101, the curved touch display device 102, and the user perception device 103 may be in a wired connection or a wireless connection. The wired connection is adapted to scenarios with high requirements for transmission stability, and the wireless connection is adapted to scenarios where flexible deployments are required.

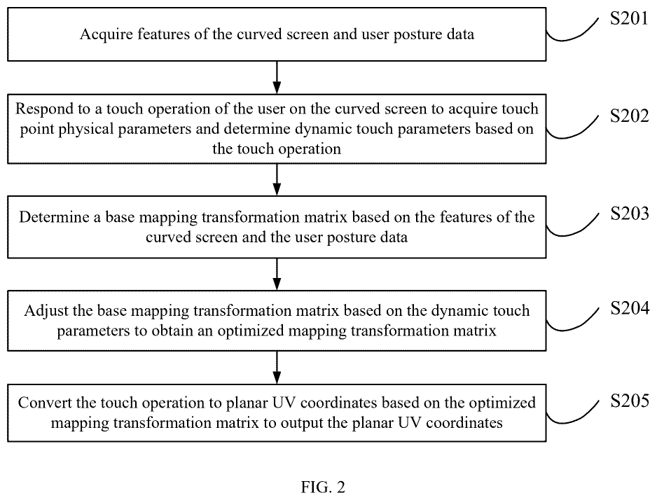

FIG. 2 is a flowchart of one interaction method for curved screen touch with planar mapping provided by an embodiment of the present disclosure. The method is executed by the computer device. The computer device may be the computer device 101 in FIG. 1. The interaction method for curved screen touch with planar mapping provided by the embodiment of the present disclosure may be adapted to scenarios where high-precision human-computer interactions are achieved through the curved screen and an interaction logic depends on the planar UI system, such as an in-vehicle smart cockpit, an immersive gaming device, a large-scale exhibition interactive device, and the like.

As shown in FIG. 2, the interaction method for curved screen touch with planar mapping provided by the embodiment of the present disclosure may include:

S201: Features of the curved screen and user posture data are acquired.

In some embodiments, the features of the curved screen include a curvature type, a physical dimension, a curvature radius, a spatial position, and an initial posture.

The curvature type includes a cylindrical surface or a local spherical surface.

The physical dimension refers to an actual geometrical parameter of the curved screen, including an arc length, a vertical height, and a screen thickness, configured to determine a spatial coverage of the curved surface.

The curvature radius refers to a parameter describing the curvature degree of the curved screen. The curvature radius of the cylindrical surface is a radius of an arc of a curved cross-section, the curvature radius of the local spherical surface is a spherical radius of the corresponding spherical surface, and the smaller the radius, the greater the curvature degree of the curved surface.

The spatial position refers to a mounting position of the curved screen in the three-dimensional coordinate system, which is usually represented by three-dimensional coordinates (x, y, z) of a central point of the screen and configured to position a specific orientation of the screen in the physical space.

The initial posture refers to a mounting angle of the curved screen, which includes an elevation angle around an x-axis, a yaw angle around a y-axis, and a roll angle around a z-axis and is configured to describe an inclination relationship between the screen and a horizontal plane or a reference coordinate system.

By way of example, the user posture data include a face orientation angle, gaze focus point coordinates, and a relative distance between the user and the curved screen.

S202: Dynamic touch parameters based on the touch operation are determined in response to the touch operation of the user on the curved screen.

The dynamic touch refers to an interactive action generated when the user makes contact with or approaches the surface of the curved screen through a medium such as a finger or a stylus, including clicking, sliding, pressing, zooming, and the like.

The touch point physical parameters refer to physical quantity data related to the touch operations, which is directly acquired by the touch sensor of the curved screen.

In some embodiments, three-dimensional spatial coordinates, a touch pressure value, a contact area, and a touch movement speed of the touch operation on the curved screen are collected, and the three-dimensional spatial coordinates, the touch pressure value, the contact area, and the touch movement speed are determined as the dynamic touch parameters.

Specifically, the three-dimensional spatial coordinates refer to position parameters in the curved surface coordinate system of the curved screen, which are calculated through an array distribution of the touch sensor. The touch pressure value refers to a pressure intensity of the touch medium on the screen surface, which is usually converted to a number representation from a voltage signal of the pressure sensor. The contact area refers to the contact region area between the touch medium and the screen surface, which is estimated through a trigger range of the multi-point touch sensor. The touch movement speed refers to a displacement change rate of the touch point in a continuous touch process, which is calculated based on a coordinate difference and a time interval of adjacent sampling moments.

Optionally, when the multi-point touch operation is detected, the dynamic touch parameters further include a relative position relationship and a touch time sequence of each touch point. When a contact point triggered first is marked as a main contact point, which is configured to support multi-finger gesture recognition.

For example, when the user slides a finger on the curved in-vehicle screen to adjust the volume, the system collects the three-dimensional coordinates of each point on a sliding trajectory, a pressure of the finger to the screen, a contact area between the fingertip and the screen, and a sliding speed, and integrates these parameters into the dynamic touch parameters for optimizing subsequent coordinate mapping precision.

S203: A base mapping transformation matrix is determined based on the features of the curved screen and the user posture data. In some embodiments, a three-dimensional curved surface model is constructed based on the features of the curved screen, and a spatial projection relationship from a perspective of the user is determined in combination with the user posture data.

By way of example, when the curvature type of the curved screen is the cylindrical surface, a first three-dimensional model with a center of a curved surface as an origin and an axial direction in a horizontal direction is constructed according to the physical dimension and the radius of curvature of the curved screen; and when the curvature type of the curved screen is the partial spherical surface, a second three-dimensional model corresponding to the partial spherical surface is constructed according to the physical dimension and the radius of curvature of the curved screen.

Specifically, when the three-dimensional curved surface model is constructed, it is necessary to convert the physical parameters of the curved screen to a mathematical expression.

For the cylindrical surface model: taking the center of the curved surface as the origin (0,0,0), extending along the x-axis, a curved surface equation is x²+y²+z²=R², where R represents the curvature radius, and a range of the x-axis is limited by the arc length, such as [−L/2, L/2], and L represents the arc length; a range of the z-axis is limited by the vertical height, such as [0,H], and H is a screen height, thus, forming an intact local cylindrical surface model.

For the local spherical surface model: taking a spherical center as an origin (0,0,0), a curved surface equation is x²+y²+z²=R², where R represents the curvature radius, and a part of the spherical surface is intercepted according to the physical dimension, thus forming the local spherical surface model fitting the actual shape of the screen.

After the three-dimensional curved surface model is constructed, the spatial projection relationship is calculated in combination with the user posture data: the line of sight direction vector is determined based on the face orientation angle of the user, and coordinates of the user eyes or the virtual observation point in the three-dimensional coordinate system are calculated in combination with the relative distance; taking the virtual observation point as a projection origin, any point on the curved surface model is projected to a preset planar interaction interface along the line of sight direction, and a one-to-one corresponding relationship between the curved surface point and the planar point is obtained through geometric operation to generate a 4×4 base mapping transformation matrix including rotation, translation, and scaling parameters.

The virtual observation point refers to a viewpoint origin in the three-dimensional space when the user observation of the curved screen is simulated, which is usually a spatial coordinate point set based on the average position of eyes of the user or a line of sight intersection point. The virtual observation point is a core reference point for constructing a spatial projection relationship from the perspective of the user, configured to simulate the spatial position through which the user “observes the screen”.

Specifically, the virtual observation point is determined in combination with the user posture data: the spatial direction of the line of sight is calculated based on the face orientation angle, the distance between the user and the screen is determined in combination with the relative distance between the user and the curved screen, and then the precise position of the observation point is calibrated through coordinates of a line of sight focusing point to finally form a virtual observation origin.

In mapping transformation, the virtual observation point, similar to a lens position of a camera, projects a point on the three-dimensional curved surface model to the planar interaction interface along the line of sight direction from the point, so as to generate a mapping relationship in accordance with visual perception of the user.

For example, when the head of the user tilts toward the left side of the screen, the virtual observation point shifts leftward, and the coordinates projected onto the planar interaction interface are adjusted accordingly, which ensures that the touch position of the curved screen seen by the user maintains visual consistency with a response position of the planar UI.

Optionally, when the base mapping transformation matrix is generated, the coordinates of the line of sight focusing point of the user may be introduced as a constraint condition to ensure that the mapping error at the focusing point is minimized, for example, the coordinates of the gaze landing point on the curved surface model are precisely mapped to the center of a corresponding functional zone of the planar UI.

For example, in an in-vehicle cylindrical screen scenario, when the curvature radius of the screen is 500 mm, the arc length is 1,200 mm, and the height is 800 mm, after the cylindrical surface model is constructed, the coordinates of the virtual observation point of a driver are calculated in combination with the face orientation angle of the driver and the relative distance of 1,500 mm between the driver and the screen. The touch point on the cylindrical surface is projected to the coordinate system of the planar UI of the in-vehicle system through the perspective projection algorithm to generate the base mapping transformation matrix, so as to ensure that the left functional zone corresponding to the planar UI responds precisely when the driver touches the left region of the screen.

S204: The base mapping transformation matrix is adjusted based on the dynamic touch parameters to obtain an optimized mapping transformation matrix.

The base mapping transformation matrix refers to an initial matrix generated based on the physical features of the curved screen and the user posture data, is configured to establish a base projection relationship from the three-dimensional curved surface model of the curved screen to the planar interaction interface, and is a reference framework for coordinate conversion. The core function of the base mapping transformation matrix is to initially map points in the curved surface space to the planar coordinate system, thereby eliminating the systematic deviation caused by the screen curvature and the viewing angle of the user.

The optimized mapping transformation matrix refers to a matrix obtained by performing adaptive adjustments on the base mapping transformation matrix in combination with dynamic touch parameters. The optimized mapping transformation matrix can further compensate for the mapping error caused by differences in real-time touch operations, making the coordinate conversion more consistent with the actual operation intention of the user.

In some embodiments, a spatial direction vector of a line of sight of the user is determined based on the face orientation angle in the user posture data; a virtual observation point position of the perspective of the user is determined based on the spatial direction vector of the line of sight of the user, the relative distance between the user and the curved screen, and the gaze focus point coordinates; with the virtual observation point as an origin, a perspective projection relationship from a three-dimensional curved surface model of the curved screen to a planar interaction interface is constructed, and projection transformation parameters from any point on the curved surface model to the planar interaction interface are determined; and the projection transformation parameters are integrated into a matrix of a preset dimension to generate the base mapping transformation matrix.

Determining the spatial direction vector of the line of sight of the user includes: calculating the three-dimensional direction of the line of sight through the face orientation angle.

Specifically, taking the central point of the face of the user as an origin, the line of sight corresponding to the pitch angle of the human face is deflected in the vertical direction, the line of sight corresponding to the yaw angle is deflected in the horizontal direction, and the line of sight corresponding to the roll angle is finely adjusted in the depth direction. Finally, the angle parameters are converted to unit vectors, i.e., the spatial direction vectors of the line of sight of the user.

Specifically, when the pitch angle of the human face is θ, defined as positive upward, and the yaw angle is φ, defined as positive rightward, the line of sight direction vectors may be calculated by trigonometric functions:
xdir=cos θ·cos φ, ydir=cos θ·sin φ, zdir=sin θ, which are used to quantify the direction of the line of sight in the three-dimensional space.

The relative distances between the spatial direction vectors of the line of sight of the user and the user and the curved screen mean that the former describes the direction in which the line of sight of the user extends, and the latter represents the average straight-line distance from the face of the user to the surface of the curved screen. A combination of the two may determine the spatial path direction vector of the line of sight from the eyes of the user to the screen surface, which defines the direction of the path. The relative distances limit the length of the path, which are jointly configured to position the spatial position relationship between the virtual observation point and the screen.

The coordinates of the focusing point of the line of sight refer to the coordinates of an intersection point between the spatial direction vector of the line of sight of the user and the surface of the curved screen in the three-dimensional coordinate system. The intersection points refer to the actual positions on the screen that the user is gazing at. For example, when the user looks toward the middle region of the curved screen, the coordinates of the focusing point of the line of sight are the three-dimensional coordinates of this region on the curved surface model.

The projection transformation parameters refer to a parameter set that describes a conversion rule from the points on the three-dimensional curved model of the curved screen to the points on the planar interaction interface, including:
a rotation parameter, configured to correct an angular deviation between the curved surface and the planar surface, such that the projection direction is consistent with the line of sight of the user;
a translation parameter, configured to adjust the position of the origin of the planar interaction interface, so as to ensure that the central point of the curved surface is flush with the origin of the plane;
a scaling parameter, configured to match the physical dimensions of the curved surface and the pixel range of the planar interaction interface, so as to prevent the mapped coordinates from exceeding the boundary of the plane; and
a perspective distortion correction parameter, configured to compensate for the phenomenon of “near larger, far smaller” caused by the tilt of the viewing angle of the user, such that the points at the edge of the curved surface are not distorted after being mapped to the plane.

Specifically, the projection transformation parameters are obtained by geometric operations: for example, for a point P (x1,y1,z1) on the cylindrical screen, taking the virtual observation point O as an origin, P is projected to the planar interaction interface in the direction of the line of sight, and coordinates of a projection point P′(x2,y2) are calculated, where a scaling ratio of x2 to x1, offsets of y2 and y1, and the like are the projection transformation parameters.

For example, in an in-vehicle scenario, the yaw angle of the face of the driver is 15°, the relative distance is 1.2 m, and the focusing point of the line of sight is a navigation button on the right side of the screen. By calculating the line of sight direction vector, the position of the virtual observation point is determined in combination with the relative distance. Then, the points on the curved surface model of the screen are projected to the in-vehicle system plane UI in the direction of the line of sight to obtain the projection transformation parameters, such as the rotation parameter and the scaling parameter, configured to generate the base mapping transformation matrix.

The matrix of preset dimensions refers to the 4×4 dimension matrix commonly used in computer graphics. The matrix of the dimensions may simultaneously include the rotation, translation, scaling, and perspective distortion correction parameters, which achieves efficient conversion from three-dimensional points to two-dimensional points through matrix multiplication, and a standard matrix form in the fields of graphics rendering and coordinate mapping.

In some embodiments, the touch pressure value is mapped to an adjustment coefficient of a nonlinear compensation function, a curved surface curvature deviation compensation value is determined based on the contact area, a motion trajectory prediction weighting factor is generated based on the touch movement speed, the adjustment coefficient, the curved surface curvature deviation compensation value, and the motion trajectory prediction weighting factor are determined as compensation parameters, and the base mapping transformation matrix is adjusted based on the compensation parameters to form the optimized mapping transformation matrix.

Specifically, in this process, the physical features of the touch operations are dynamically sensed to finely correct the base mapping transformation matrix: first, the touch pressure value is converted to an adjustment coefficient of a predetermined nonlinear compensation function, the larger the pressure, the greater the coefficient value. Moreover, the curvature change rate of the curved surface where the touch point is located is determined according to the size of the contact area, the contact area is smaller, the touch point may be located in a curvature mutation region, and the corresponding curved surface curvature deviation compensation value is calculated. Then, a motion trajectory prediction weighting factor is generated based on the touch movement speed, the higher the speed, the more the factor tends toward trajectory smoothing. Finally, the three parameters are integrated into a compensation vector to adjust the elements of the base mapping transformation matrix in a targeted manner.

The adjustment coefficient of the nonlinear compensation function refers to a parameter configured to control a nonlinear compensation intensity, the value of which is positively correlated with the touch pressure. This coefficient is calculated by the nonlinear function and plays a role in enhancing the mapping precision weight of a peripheral region of the touch point when the user applies a large pressure, thereby reducing the offset error of the touch point caused by the pressure.

The curved surface curvature deviation compensation value refers to a parameter configured to correct a mapping deviation of a region with an uneven curvature of the curved screen. The value of the curved surface curvature deviation compensation value is jointly decided by the contact area and the curvature radius of this region: in a region where the curvature changes gently, the contact area has a smaller impact on the compensation value. In the curvature mutation region, such as a transition area between the cylindrical surface and the planar surface or the local edge of the spherical surface, the smaller the contact area, the larger the compensation value, configured to offset coordinate distortion caused by the geometric features of the curved surface.

The motion trajectory prediction weighting factor refers to a parameter configured to balance real-time performance and trajectory smoothness, the value of which is positively correlated with the touch movement speed. This factor performs a weighted correction on the current mapping result by predicting the touch point coordinates at the next moment. When the speed is relatively high, the smoothing weight is increased to reduce jitter, and when the speed is relatively low, the weight is decreased to maintain positioning accuracy.

Adjusting the base mapping transformation matrix based on the compensation parameters to form the optimized mapping transformation matrix includes:

The adjustment coefficient of the nonlinear compensation function is multiplied by the diagonal elements of the base matrix to enhance the coordinate conversion weight in a high-pressure region, the curved surface curvature deviation compensation value is superimposed onto the edge region parameters of the base matrix to correct the mapping deviation caused by curvature mutation, and weighted fusion of the motion trajectory prediction weighted factor and the adjacent frame conversion results of the base matrix is performed to generate a smooth trajectory mapping matrix. By integrating the above adjustments, the final optimized mapping transformation matrix is obtained.

Specifically, assuming that the base mapping transformation matrix is M, the adjustment coefficient is α, the curved surface curvature deviation compensation value is β, and the motion trajectory prediction weighted factor is γ, a calculation mode of the optimized matrix M′ is as follows:

$${M}^{′} = α \cdot diag ( M ) + β \cdot E + γ \cdot {M}_{prev}$$

where diag(M) represents a diagonal element matrix of M, E represents an edge compensation matrix, and Mₚᵣₑᵥ represents a mapping matrix at the previous moment.

Optionally, when the pressure value or the movement speed of the detected touch operation exceeds a preset threshold, an emergency compensation mode may be initiated to temporarily enhance the weight of the compensation parameters, so as to guarantee the interaction stability preferentially.

For example, when the user slides fast and applies a moderate pressure in a region with a large curvature on the curved screen, the system maps the pressure value 500 as the adjustment coefficient 1.3, the deviation compensation value 0.05 is calculated according to the contact area 20 mm² and the curvature radius of this region, and the weighted factor 0.7 is generated based on the speed 160 mm/s. After the base matrix is adjusted by the above formula, the obtained optimized matrix enables the mapping of a fast sliding trajectory on the planar UI to have no obvious offset, avoid jitter, and improve interaction fluency.

S205: The touch operation is converted to planar UV coordinates based on the optimized mapping transformation matrix to output the planar UV coordinates.

In some embodiments, three-dimensional spatial coordinates of the touch operation are acquired; the three-dimensional spatial coordinates are put into the optimized mapping transformation matrix to obtain original coordinates in a planar coordinate system; and the original coordinates are normalized to obtain the planar UV coordinates with a value range of [0, 1].

Optionally, boundary verification on the planar UV coordinates is performed. When the boundary exceeds the preset planar interaction region, the exceeding part is intercepted by the boundary of this region.

Specifically, the planar UV coordinate range of the preset planar interaction region is [0,1]×[0,1], i.e., u∈[0,1] and v∈[0,1]). The boundary verification is achieved by the following steps:
a value u and a value v of the planar UV coordinates are extracted;
whether the value u is less than 0 or greater than 1 is determined; when u is less than 0, u is corrected forcefully to 0, and when u is greater than 1, u is corrected to 1 forcefully;
the value v is determined in a similar manner: when v is less than 0, v is corrected to 0, and when v is greater than 1, v is corrected to 1;
after the correction, it is ensured that the output UV coordinates fall within the preset planar interaction region all the time, preventing coordinates from exceeding the effective interaction range due to mapping errors, thereby ensuring that the planar interaction logic can respond effectively to all touch operations.

For example, when the planar UV coordinates output by the optimized mapping transformation matrix are (−0.05, 1.08), where the value u (−0.05) is less than 0, and the value v (1.08) is greater than 1; after boundary verification, the value u is corrected to 0, the value v is corrected to 1, and finally, (0,1) is output. These coordinates correspond to a boundary point at the bottom left of the planar interaction interface, ensuring the system can identify and respond to the touch operation, rather than causing interaction failure due to invalid coordinates.

Specifically, this process is a core step of converting the touch position on the curved screen from the three-dimensional physical space to recognizable standardized coordinates of the planar interaction system:
the three-dimensional spatial coordinates are acquired: the touch sensor of the curved screen directly collects the three-dimensional coordinates (x,y,z) of the touch point in the curved surface coordinate system of the curved screen and converts the three-dimensional coordinates to a coordinate system (for example, the coordinate system taking the center of the screen as the origin) consistent with a global three-dimensional model, and a matrix operation is performed to obtain original coordinates: the three-dimensional coordinates (x,y,z) are represented in a homogeneous coordinate form (x,y,z,1) and a multiplication operation is performed with the optimized mapping transformation matrix to obtain two-dimensional original coordinates (u0,v0) in the planar coordinate system. These coordinates reflect the initial mapping position of the touch point in the planar interaction interface. The two-dimensional original coordinates (u0,v0) are converted to relative values in an interval of [0,1] according to the physical dimensions or pixel range (such as width W and height H) of the planar interaction interface. A calculation formula is as follows:

$$u = \frac{u 0}{W}$$

$$v = \frac{v 0}{H}$$

Finally, the planar UV coordinates (u,v) are obtained.

Through normalization, the planar UV coordinates may break away from the constraints of specific planar dimensions and directly adapt to planar UI systems with different resolutions or sizes, ensuring the universality of mapping results.

Optionally, before the three-dimensional spatial coordinates are input into the optimized mapping transformation matrix, a filtering preprocess is performed on the coordinates to eliminate abnormal points caused by sensor noise, thereby preventing the original coordinate errors from affecting the accuracy of the final UV coordinates.

Optionally, when the planar interaction interface is divided into a plurality of regions, a region mapping step may be added after normalization: the planar UV coordinates are mapped to local UV coordinates in the corresponding region according to the value range of the planar UV coordinates (for example, u∈[0,0.5] corresponds to the left region and u∈[0.5,1] corresponds to the right region. The normalized planar UV coordinates are mapped to the local UV coordinates of the corresponding region, thereby facilitating processing of the regional interaction logic.

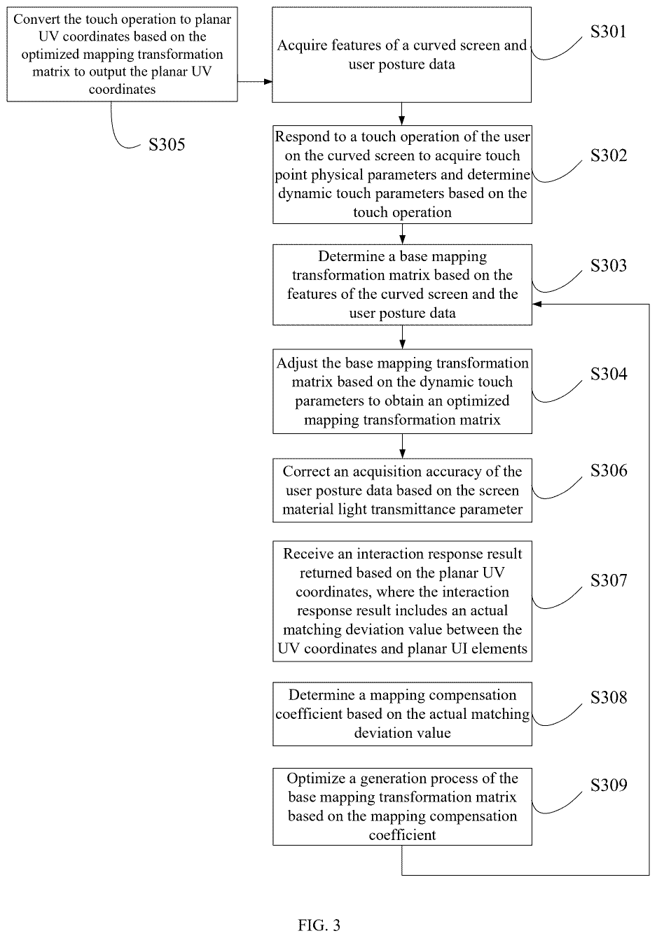

FIG. 3 is a flowchart of another interaction method for curved screen touch with planar mapping provided by an embodiment of the present disclosure. The method is executed by a computer device, and the computer device may be the computer device 101 in FIG. 1.

S301: Features of a curved screen and user posture data are acquired.

The description of this step may be referred to Step S201, which is no longer repeatedly described herein.

S302: Dynamic touch parameters are determined based on the touch operation in response to a touch operation of the user on the curved screen.

The description of this step may be referred to Step S202, which is no longer repeatedly described herein.

S303: A base mapping transformation matrix is determined based on the features of the curved screen and the user posture data.

The description of this step may be referred to Step S203, which is no longer repeatedly described herein.

S304: The base mapping transformation matrix is adjusted based on the dynamic touch parameters to obtain an optimized mapping transformation matrix.

The description of this step may be referred to Step S204, which is no longer repeatedly described herein.

S305: The touch operation is converted to planar UV coordinates based on the optimized mapping transformation matrix to output the planar UV coordinates.

The description of this step may be referred to Step S205, which is no longer repeatedly described herein.

S306: An acquisition accuracy of the user posture data is corrected based on the screen material light transmittance parameter.

Specifically, the screen material light transmittance parameter will affect the recognition accuracy of a user posture acquisition device for the facial features of the user: when the light transmittance is low, the reflected light of the screen is strong or the light transmittance is insufficient, which may result in blurred captured facial images and increased error in feature point extraction, and when the light transmittance is high, environmental light interference may increase, leading to fluctuations in posture data. The correcting process includes:

The screen material light transmittance parameter is pre-stored, such as a normalized value of 0.3-0.8, where 0 represents that the screen is completely opaque and 1 represents that the screen is completely transparent;
when the light transmittance is less than 0.5, the exposure time and the image gain of the user perception device are adjusted to enhance the contrast of the facial feature;
when the light transmittance is greater than or equal to 0.5, an ambient light filtering algorithm is enabled to eliminate the spot noise generated by strong light passing through the screen, and optimize the calculation accuracy of the human face orientation angle and the line-of-sight focus point;
the corrected image or sensor data is input into a posture analysis model again to output calibrated user posture data.

Optionally, a light transmittance-correction parameter comparison table is established. The corresponding correction strategy is dynamically invoked according to the light transmittance detected in real time. For example, the light transmittance 0.3 corresponds to the exposure time+50%, and the light transmittance 0.7 corresponds to the filtering intensity +40%, thereby achieving adaptive correction.

The screen material light transmittance refers to a proportion of light rays allowed to pass through a panel of the curved screen, which is usually represented by a percentage or a normalized value of 0-1. This parameter is decided by the screen material and the surface treatment process, which directly affects the visual signal capture quality of the user behind or in front of the screen by the user posture acquisition device.

S307: An interaction response result returned is received based on the planar UV coordinates, where the interaction response result comprises an actual matching deviation value between the planar UV coordinates and planar UI elements.

Optionally, when the matching deviation value exceeds the preset threshold, the mapping compensation coefficient is calculated based on the deviation value. The compensation coefficient is positively correlated with the deviation value. The mapping compensation coefficient is injected into the generation process of the next base mapping transformation matrix to perform iterative correction on the projection relationship between the three-dimensional curved surface model and the planar interaction interface to periodically store the mapping transformation matrix parameters after iterative correction, so as to form a historical optimized database. When the same user posture and touch feature are detected, the historical optimal parameter is invoked as an initial value.

The interaction response result refers to feedback information returned after the planar interaction system analyzes the input planar UV coordinates, configured to indicate a matching degree between the touch operation and an expected interaction target.

The planar UI elements refer to interactive visual assemblies in the planar interaction interface, such as buttons, slide blocks, icons, and textboxes. Each element has a fixed position range in the planar coordinate system. For example, the planar UV coordinate range [0.2,0.3]×[0.4,0.5] corresponds to a “confirm” button.

The actual matching deviation value refers to a distance difference value between the central position of the target planar UI elements and the effective range, and the normalized coordinate difference usually represents the deviation value (0.028) of the center of the target element. The greater the deviation value, the lower the mapping precision.

S308: A mapping compensation coefficient is determined based on the actual matching deviation value.

Specifically, the mapping compensation coefficient is positively correlated with the actual matching deviation value, which is calculated by the following preset function relationship:
when the deviation value is less than or equal to 0.01, the compensation coefficient is set to 0 (is not adjusted);
when the deviation value is greater than 0.01 but less than or equal to 0.05, the compensation coefficient is equal to deviation value×20 (linear increase, for example, the deviation value 0.03 corresponds to the coefficient 0.6);
when the deviation value is greater than 0.05, the compensation coefficient is equal to 1+ (deviation value−0.05)×10 (nonlinear increase, for example, the deviation value 0.06 corresponds to the coefficient 1.1).

In this manner, the greater the deviation, the greater the compensation coefficient, ensuring a higher correction degree on low-precision mapping.

Optionally, a historical deviation accumulated value is introduced. When the deviation value is greater than 0.03 for three successive times, the compensation coefficient is increased additionally to 20%, thereby preventing accumulation of systematic deviations.

The mapping compensation coefficient refers to a parameter configured to correct the base mapping transformation matrix, the value of which reflects the compensation level of the current mapping deviation. The greater the coefficient, the larger the adjustment range of the base matrix, configured to reduce similar deviations in a subsequent mapping process.

S309: A generation process of the base mapping transformation matrix is optimized based on the mapping compensation coefficient.

Specifically, the mapping compensation coefficient is injected into the generation link of the base mapping transformation matrix, to achieve targeted optimization:
when the three-dimensional curved surface model of the curved screen is constructed, local parameters of the model are adjusted according to the compensation coefficient, such as curvature radius correction±coefficient×0.01R, where R represents the original curvature radius, such that the model is more adapted to the actual interaction requirements;
when the spatial projection relationship of the viewing angle of the user is calculated, the compensation coefficient is associated with the position of the virtual observation point to correct the deviation in the projection direction; and
when the projection transformation parameters are integrated to generate the base matrix, system weighing is applied to the elements corresponding to the deviation region in the matrix to enhance the mapping precision of this region.

Through the above steps, the optimized base matrix can actively counteract the historical deviations, thereby enhancing the mapping stability.

Optionally, a compensation coefficient-matrix parameter adjustment comparison table is established. A common deviation scenario is associated with a preset matrix adjustment solution to achieve fast optimization; moreover, after 100 interaction responses are accumulated, a global calibration is performed on the base matrix based on the average compensation coefficient to avoid parameter drift.

The above descriptions mainly introduce the solutions provided by the present disclosure. Correspondingly, the present disclosure further provides an interaction system for curved screen touch with planar mapping, configured to implement the above method embodiments.

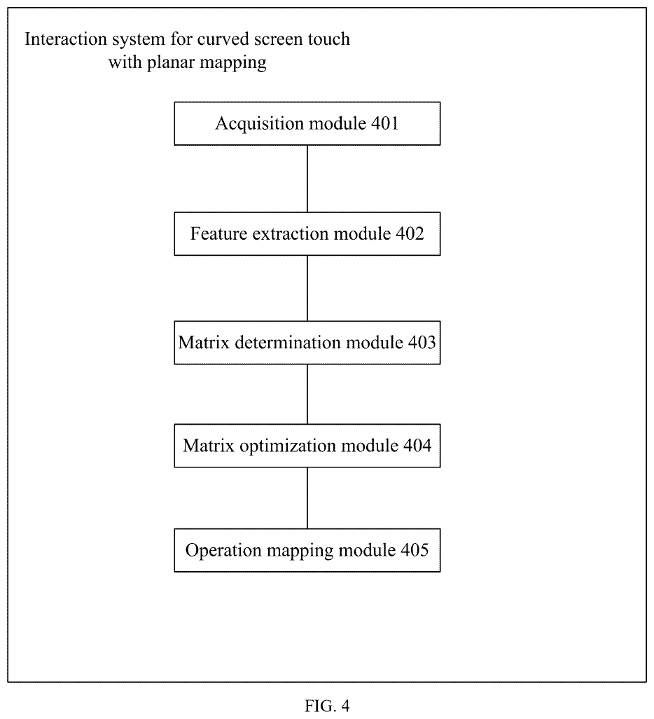

FIG. 4 is a schematic structural diagram of an interaction system for curved screen touch with planar mapping provided by an embodiment of the present disclosure. The interaction system for curved screen touch with planar mapping may include an acquisition module 401, a feature extraction module 402, a matrix determination module 403, a matrix optimization module 404, and an operation mapping module 405. The acquisition module 401 is configured to execute the operation of S201 in the method shown in FIG. 2 and the operation of S301 in the method shown in FIG. 3. The feature extraction module 402 is configured to execute the operation of S202 in FIG. 2 and the operation of S302 in FIG. 3. The matrix determination module 403 is configured to execute the operation of S203 in FIG. 2 and the operation of S303 in the method shown in FIG. 3. The matrix optimization module 404 is configured to execute the operation of S204 in FIG. 2 and the operation of S304 in the method shown in FIG. 3. The operation mapping module 405 is configured to execute the operation of S205 in FIG. 2 and the operation of S305 in the method shown in FIG. 3.

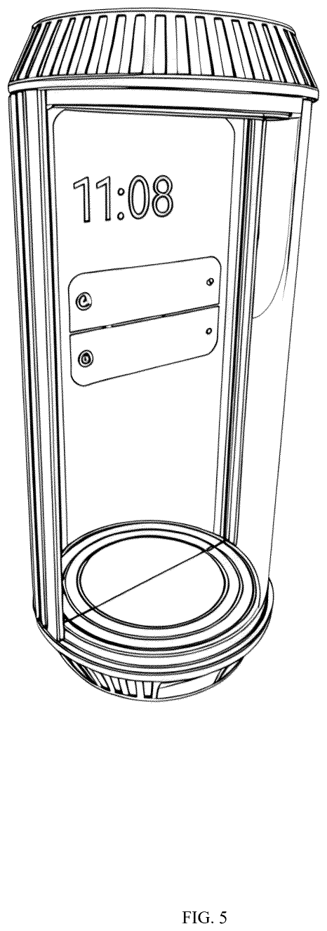

FIG. 5 is a schematic diagram of a product of an interaction system for curved screen touch with planar mapping provided by an embodiment of the present disclosure.

In some embodiments, to implement the above functions, the interaction system for curved screen touch with planar mapping includes corresponding hardware structures and/or software modules for achieving each function. It should be readily appreciated by those skilled in the art that, in combination with the units and algorithm steps of each example described in the embodiments disclosed herein, the present disclosure can be implemented in the form of hardware or a combination of hardware and computer software. Whether a specific function is executed by hardware or by computer software driving hardware depends on the specific disclosure and design constraints of the technical solution. Professional technicians may use different methods to implement the described function for each specific disclosure, but such implementation should not be considered to go beyond the scope of the present disclosure.

In the embodiments of the present disclosure, the interaction system for curved screen touch control and planar mapping may be divided into functional modules according to the above method embodiments. For example, each functional module may be divided corresponding to each function, or two or more functions may be integrated into a single processing module. The aforementioned integrated modules may be implemented either in the form of hardware or in the form of software functional modules. It should be noted that the division of modules in the embodiments of the present disclosure is illustrative and merely a logical function division; there may be other division methods in actual implementation.

From the description of the above implementation modes, those skilled in the art may clearly understand that, for convenience and conciseness of description, only the division of the above functional modules is taken as an example for illustration. In practical applications, the above functions may be allocated to be completed by different functional modules as required, that is, the internal structure of a module is divided into different functional modules to complete all or part of the functions described above. The specific working processes of the system, modules, and units described above may refer to the corresponding processes in the aforementioned method embodiments, and will not be repeated here.

Since the interaction system for curved screen touch control and planar mapping in the embodiments of this invention may be applied to the above-mentioned method, the technical effects it may achieve may also refer to the above-mentioned method embodiments, and will not be repeated in the embodiments of this invention.

The method steps in this embodiment may be implemented by means of hardware, or may be implemented by a processor executing software instructions. The software instructions may consist of corresponding software modules, and the software modules may be stored in a random access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a CD-ROM, or any other form of storage medium known in the art. An exemplary storage medium is coupled to a processor, enabling the processor to read information from the storage medium and write information to the storage medium. Of course, the storage medium may also be an integral part of the processor. The processor and the memory medium may be located in the ASIC. In addition, the ASIC may be located in a network device. Of course, the processor and the storage medium may also exist as discrete components in a network device.

In the above-described embodiments, implementation may be accomplished in whole or in part through software, hardware, firmware, or any combination thereof. When implemented using software, it may be implemented in whole or in part in the form of a computer program product. The computer program product includes one or more computer programs or instructions. When computer programs or instructions are loaded and executed on a computer, the processes or functions of the embodiments of the present disclosure are executed in whole or in part. The computer may be a general-purpose computer, a special-purpose computer, a computer network, a network device, a user equipment, or another programmable module. Computer programs or instructions may be stored in a computer-readable storage medium, or transmitted from one computer-readable storage medium to another. For example, computer programs or instructions may be transmitted from one website, a computer, a server, or a data center to another website, a computer, a server, or a data center in a wired or wireless manner. A computer-readable storage medium may be any available medium that may be accessed by a computer, or a data storage device such as a server or a data center integrating one or more available media. The available medium may be a magnetic medium, such as a floppy disk, a hard disk, or a magnetic tape; an optical medium, such as a digital video disc (DVD); or a semiconductor medium, such as a solid state drive (SSD). The above descriptions are merely specific implementations of the present disclosure, but the protection scope of the present disclosure is not limited thereto. Those skilled in the art can easily think of various equivalent modifications or substitutions within the technical scope disclosed by the present disclosure, and all such modifications or substitutions should be covered within the protection scope of the present disclosure. Therefore, the protection scope of the present disclosure should be subject to the protection scope defined by the claims.

What is claimed is:

1. An interaction method for curved screen touch with planar mapping, comprising:
acquiring features of a curved screen and user posture data;
responding to a touch operation of a user on the curved screen, and determining dynamic touch parameters based on the touch operation;
determining a base mapping transformation matrix based on the features of the curved screen and the user posture data;
adjusting the base mapping transformation matrix based on the dynamic touch parameters to obtain an optimized mapping transformation matrix; and
converting the touch operation to planar UV coordinates based on the optimized mapping transformation matrix to output the planar UV coordinates.

2. The method according to claim 1, wherein the responding to a touch operation of a user on the curved screen, and determining dynamic touch parameters based on the touch operation comprises:
collecting three-dimensional spatial coordinates, a touch pressure value, a contact area, and a touch movement speed of the touch operation on the curved screen; and
determining the three-dimensional spatial coordinates, the touch pressure value, the contact area, and the touch movement speed as the dynamic touch parameters.

3. The method according to claim 1, wherein the determining a base mapping transformation matrix based on the features of the curved screen and the user posture data comprises:
constructing a three-dimensional curved surface model based on the features of the curved screen; determining a spatial projection relationship from a perspective of the user in combination with the user posture data; and generating the base mapping transformation matrix, wherein the features of the curved screen comprise a curvature type, a physical dimension, a radius of curvature, a spatial position, and an initial posture; the user posture data comprises a face orientation angle, gaze focus point coordinates, and a relative distance between the user and the curved screen; and the curvature type comprises a cylindrical surface or a partial spherical surface.

4. The method according to claim 3, wherein the constructing a three-dimensional curved surface model based on the features of the curved screen comprises:
when the curvature type of the curved screen is the cylindrical surface, constructing a first three-dimensional model with a center of a curved surface as an origin and an axial direction of the first three-dimensional model in a horizontal direction according to the physical dimension and the radius of curvature of the curved screen; and
when the curvature type of the curved screen is the partial spherical surface, constructing a second three-dimensional model corresponding to the partial spherical surface according to the physical dimension and the radius of curvature of the curved screen.

5. The method according to claim 3, wherein the generating a base mapping transformation matrix comprises:
determining a spatial direction vector of a line of sight of the user based on the face orientation angle in the user posture data;
determining a virtual observation point position of the perspective of the user based on the spatial direction vector of the line of sight of the user, the relative distance between the user and the curved screen, and the gaze focus point coordinates;
with the virtual observation point as an origin, constructing a perspective projection relationship from a three-dimensional curved surface model of the curved screen to a planar interaction interface, and determining projection transformation parameters from any point on the curved surface model to the planar interaction interface; and
integrating the projection transformation parameters into a matrix of a preset dimension to generate the base mapping transformation matrix.

6. The method according to claim 3, wherein the adjusting the base mapping transformation matrix based on the dynamic touch parameters to obtain an optimized mapping transformation matrix comprises:
mapping the touch pressure value to an adjustment coefficient of a nonlinear compensation function;
determining a curved surface curvature deviation compensation value based on the contact area;
generating a motion trajectory prediction weighting factor based on the touch movement speed;
determining the adjustment coefficient, the curved surface curvature deviation compensation value, and the motion trajectory prediction weighting factor as compensation parameters; and
adjusting the base mapping transformation matrix based on the compensation parameters to form the optimized mapping transformation matrix.

7. The method according to claim 1, wherein the converting the touch operation to planar UV coordinates based on the optimized mapping transformation matrix to output the planar UV coordinates comprises:
acquiring three-dimensional spatial coordinates of the touch operation;
inputting the three-dimensional spatial coordinates into the optimized mapping transformation matrix to obtain original coordinates in a planar coordinate system; and
normalizing the original coordinates to obtain the planar UV coordinates with a value range of [0, 1].

8. The method according to claim 1, wherein the features of the curved screen further comprise a screen material light transmittance parameter; and the method further comprises:
correcting an acquisition accuracy of the user posture data based on the screen material light transmittance parameter.

9. The method according to claim 1, further comprising:
receiving an interaction response result returned based on the planar UV coordinates, wherein the interaction response result comprises an actual matching deviation value between the planar UV coordinates and planar UI elements;
determining a mapping compensation coefficient based on the actual matching deviation value; and
optimizing a generation process of the base mapping transformation matrix based on the mapping compensation coefficient.

10. An interaction system for curved screen touch with planar mapping, comprising:
an acquisition module, configured to acquire features of a curved screen and user posture data;
a feature extraction module, configured to respond to a touch operation of a user on the curved screen and determine dynamic touch parameters based on the touch operation;
a matrix determination module, configured to determine a base mapping transformation matrix based on the features of the curved screen and the user posture data;
a matrix optimization module, configured to adjust the base mapping transformation matrix based on the dynamic touch parameters to obtain an optimized mapping transformation matrix; and
an operation mapping module, configured to convert the touch operation to planar UV coordinates based on the optimized mapping transformation matrix to output the planar UV coordinates.
